(19) United States
(12) Patent Application Publication
(10) Pub. No.: US 2017/0086602 A1
(43) Pub. Date: Mar. 30, 2017

(54) LADDERLESS MAGNETIC CEILING CLOTHES HANGER ADAPTER

(71) Applicants: Michael J. White, Ripon, WI (US); Brian T. White, Ripon, WI (US)

(72) Inventors: Michael J. White, Ripon, WI (US); Brian T. White, Ripon, WI (US)

(73) Assignee: K-INTERNATIONAL, INC., Waukegan, IL (US)

(21) Appl. No.: 14/869,391

(22) Filed: Sep. 29, 2015

(51) Int. Cl. A47F 5/08; B25J 1/04; A47F 7/19; F16B 1/00; F16M 13/02

(52) U.S. Cl. CPC A47F 5/0838; F16B 1/00; F16M 13/022; F16M 13/027; A47F 7/19; B25J 1/04; F16B 2001/0035

(57) ABSTRACT

An adapter for hanging a clothes hanger or other display device from a ceiling or other mounting location includes a top plate on which are mounted magnets. A neck is connected to the top plate and a channel portion is connected to the neck. An opening is formed in the neck of a size and shape to accept a hook of a clothes hanger. The opening may be shaped to permit a loop end of the hanger hook to pass only when the adapter and hanger are aligned with one another.

### BACKGROUND OF THE INVENTION

Field of the Invention

The present invention relates generally to an adapter for mounting a clothes hanger for display, and more particularly to an adapter for mounting a clothes hanger on which clothes are displayed at a display location.

Description of the Related Art

Stores, shops, markets and other locations that offer items of clothing for sale may have some of the clothing items displayed for prospective customers. For example, a clothing store may wish to display T-shirts, shirts, tops, jackets, sweatshirts, blouses, swimwear, capes, ponchos, pants, shorts, or other clothing items at locations where they are visible to prospective customers. For example, a souvenir shop in a tourist area or a store in a mall may wish to display T-shirts and sweatshirts within the store and in the windows of the shop.

Organizers of events, such a running events, volunteer events, music events, family reunions, sporting events, charity events, or other events may have T-shirts or other clothing items prepared for the event that will be distributed or sold to participants or attendants. The organizers may wish to display the clothing items for the participants or attendants. Other entities may wish to prominently display clothing items or other items for a variety of reasons.

Placement of the clothing items in positions where the prospective customers or participants are able to see them, such as near a ceiling so that they are visible above the shelves, racks and display cases of the store or in the store windows, may require store personnel, for example, to climb ladders or on boxes, chairs, or other items to reach the display location, both to place the item at the display location and to retrieve it from the display location. Placement and retrieval of the displays may lead to unsafe situations, and could cause injury if the person should fall. Even if no injuries occur, damage may occur if the merchandise in the store is knocked over while setting up or taking down the display or while moving ladders or other items to reach the display location. Shelves or display cases may be damaged in the process.

### SUMMARY OF THE INVENTION

The present invention provides an apparatus and method for display of clothing items or other items at prominent display locations. An adapter is provided for holding a clothes hanger, for example, on which an item of clothing may be hung. The adapter permits mounting and unmounting of the display while the person doing so is standing on the floor or ground. The adapter includes a portion for engagement by a pole-mounted gripper that permits the adapter to be moved to and from a display location and attached at and removed from the display location without requiring climbing by the user.

The adapter includes an attachment portion, which may include one or more magnets, that attaches the adapter to a display location. The adapter may also include a channel or other portion at which further display supporting elements may be attached or selectively engaged. In an example, hooks, clips, cords, or other display mounting items may be attached at the channel or other portion of the adapter.

### BRIEF DESCRIPTION OF THE DRAWINGS

FIG. 1 is a perspective view of a person mounting or unmounting a clothing item for display at a ceiling using a clothes hanger adapter and a pole-mounted gripper;

FIG. 2 is a perspective view of the clothes hanger adapter supporting two clothing items for display;

FIG. 3 is a perspective view of the clothes hanger adapter and a fragmentary view of a clothes hanger being mounted therein;

FIG. 4 is a perspective view of the clothes hanger adapter of FIG. 3 and a fragmentary view of a hook portion of the clothes hanger being moved into a display position;

FIG. 5 is a perspective view of the clothes hanger adapter and the fragmentary portion of the clothes hanger of FIG. 3 with the clothes hanger in a position ready for mounting and display;

FIG. 6 is a perspective view of the ladderless magnetic clothes hanger adapter including an optional end cap element;

FIG. 7 is a top plan view of the ladderless magnetic clothes hanger adapter of FIG. 6;

FIG. 8 is a side elevational view of the ladderless magnetic clothes hanger adapter and an optional end cap element;

FIG. 9 is a left-hand end elevational view of the ladderless magnetic clothes hanger adapter including the optional end cap element;

FIG. 10 is a right-hand end elevational view of the ladderless magnetic clothes hanger adapter including the optional end cap element; and

FIG. 11 is a perspective view of the ladderless magnetic clothes hanger adapter into which is being mounted a block end hook element and on which is being mounted an end cap element.

### DETAILED DESCRIPTION OF THE PREFERRED EMBODIMENTS

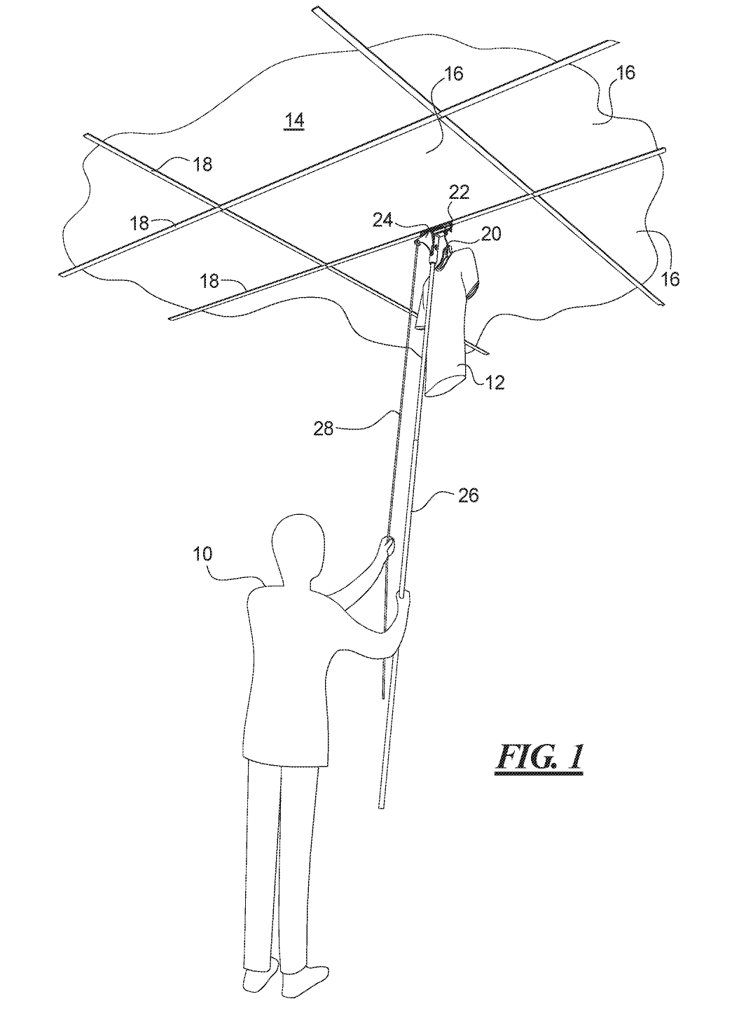

In FIG. 1, a person 10, such as a store employee or event staff, is mounting an article of clothing 12 for display adjacent a ceiling 14 of a store, shop, office, or other location. The person 10 may instead be unmounting the article of clothing 12 from the display location. The ceiling 14 includes ceiling tiles 16 that are held in place by a ceiling grid 18. The ceiling grid 18 in the example is of a ferromagnetic material to which a magnet is attracted. The article of clothing 12 is shown in the illustration as a T-shirt, although button-down shirts, pull-over shirts, blouses, tops, pajamas, dresses, gowns, jackets, sweatshirts, sweaters, coats, ponchos, pants, shorts, swimwear, and other articles of clothing or other objects may be displayed. The clothing may be for adults or children, men or women, or anyone. The article of clothing 12 is supported on a clothes hanger 20 that is held by an adapter 22. The adapter 22 is magnetically engaged to the ceiling grid 18. The person 10 is using a gripper 24 mounted on a pole 26 to move the adapter 22 into place at the display location or to remove the adapter 22 from the display location. The gripper 24 is connected to a rope or cord 28 by which the gripper 24 may be operated safely from floor level to engage and disengage the adapter 22.

To place the article of clothing 12 in the display position, the article of clothing 12 is placed on the hanger 20 and the hanger 20 is selectively affixed to the adapter 22. These steps may take place in any order. The gripper 24 has jaws that are opened and engaged on the adapter 22. A gripper 24 that may be used with the adapter is shown, for example, in co-pending application Ser. No. 14/248,899. With the adapter 22 gripped by the gripper 24, the person lifts the adapter 22 toward the display location using the pole 26. Magnets on the adapter 22 are magnetically engaged on the ceiling grid 18. The magnets may instead be magnetically engaged to a ceiling beam, metal plate, metal strip, window frame, or other ferromagnetic material mounting locations. For example, a metal plate may be added as shown in the co-pending application, or a metal strip may be added to the underside of a window frame that is not magnetically receptive. The adapter 22 may be mounted by mounting means other than magnets, if desired.

Once the adapter 22 is in place and engaged at a mounting location, the person 10 may release the gripper 24 from the adapter 22. In the illustrated example, this is performed by pulling downward on the rope or cord 28 to cause the jaws of the gripper 22 to open. While the jaws are open, the gripper 24 is moved away from the adapter 22, leaving the adapter 22 in place and the article of clothing 12 at the prominent display location. The mounting of the shirt 12 at a highly visible location adjacent the ceiling 14 is accomplished while the person's feet remain safely on the floor and without the use of a ladder, boxes or other items to climb on.

The person 10 may move the article of clothing 12 to a different location or remove the article of clothing 12 from display by moving the gripper 24 to the adapter 22 using the pole 26, opening the jaws of the gripper 24 using the rope or cord 28, and engaging the adapter 22 by releasing the rope or cord 28 so that the jaws grip the adapter 22. Once the gripper 24 is engaged on the adapter 22, the person 10 may tug on the pole 26 to release the magnetic engagement of the adapter 22 to the ceiling grid 18 or other mounting location. The adapter 22 and article of clothing 12 may then be removed from the display location near the ceiling 14 using the pole 26. The removal may be accomplished without the person 10 using a ladder. The displayed shirt or other article of clothing can be changed. If a customer wishes to purchase the displayed shirt for example it may be the only one remaining of that design, size or color, the displayed shirt or other clothing may easily be retrieved by a store clerk without use of a ladder.

The position or orientation of the displayed item may be changed using the pole 26 and gripper 24 without use of a ladder. For example, many clothing hangers have hooks that rotate relative to the body of the hanger. After the article of clothing 12 is mounted at the display location, the pole 26 and gripper 24 may be used to rotate the hook portion of the hanger 20 so that the shirt or other item 20 is directed in the desired way.

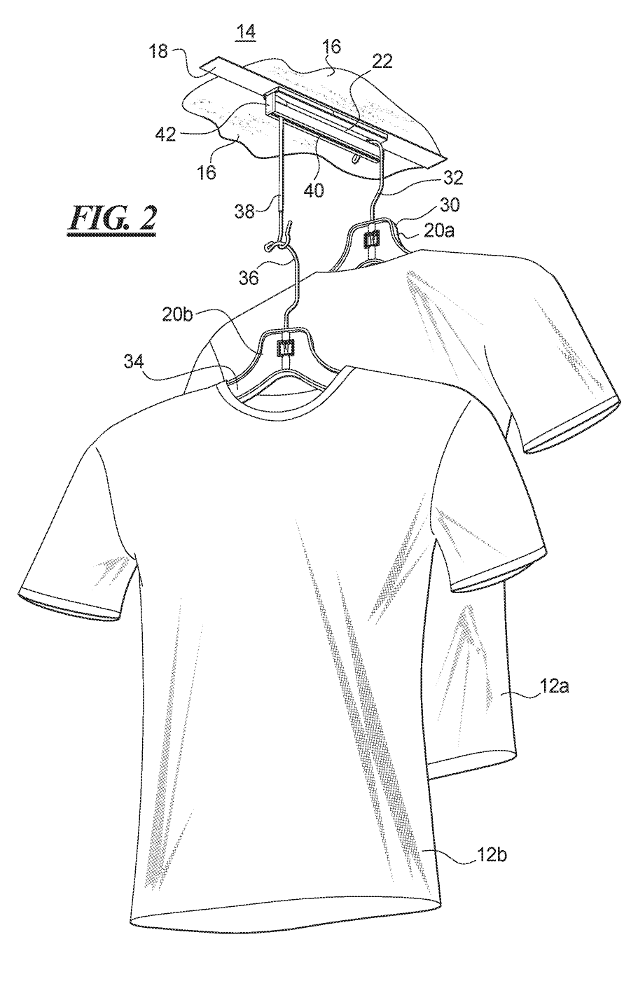

FIG. 2 shows two ways or a simultaneous way of mounting a shirt or shirts or other articles of clothing 12 on the adapter 22; the two ways may be used separately or together. A first shirt 12a or other article of clothing is hung on a clothes hanger 20a. The hanger 20a has a hanger body 30 from which extends a hanger hook 32. The hanger hook 32 is directly engaged in the adapter 22. When the adapter 22 is magnetically engaged to the ceiling grid 18, the shirt 12a is positioned near the ceiling 14. The hanger hook 32 is engaged in the adapter 22 near an end of the adapter 22 to provide a length of the adapter 22 for engagement by the gripper 24 on the pole 26, as shown in FIG. 1. The shirt 12a or other article of clothing mounted in this way may be the only article of clothing 12 or other item on the adapter 22. A plurality of the adapters 22 may be provided to display multiple shirts or other clothing or other items at locations throughout a store, shop, or other facility.

A second shirt 12b is shown in FIG. 2 mounted for display. The second shirt 12b is hung on a hanger 20b that includes a hanger body 34 and a hook 36. The hook 36 is engaged in a hook portion of a block end hook 38 that is mounted in a channel portion 40 of the adapter 22. The block end hook 38 suspends the hanger 36 at a distance below the adapter 22. The block end hook 38 may be provided in various lengths to vary the distance that the article of clothing is displayed below the ceiling 14. The height of the display may be changed as desired.

The block end hook 38 is mounted adjacent an end of the adapter 22 to provide space along the length of the adapter for gripping by the gripper 24. An end cap 42 is provided on the channel portion 40. The end cap 42 may be provided on one end, both ends, or need not be provided at all. The end cap 42 may be used to provide a decorative, finished look to the adapter 22 or further used as an end stop that helps retain hanging hardware elements within the channel 40. The shirt 12b may be displayed on the adapter 22 alone or may be displayed with the first shirt 12a. The illustration shows a staggered display of two shirts 12a and 12b. A further shirt may be provided on a shorter or longer block end hook hanging element for an additional staggered display, for example. Other arrangements of the shirts or multiple shirts or other items on display may be provided as desired.

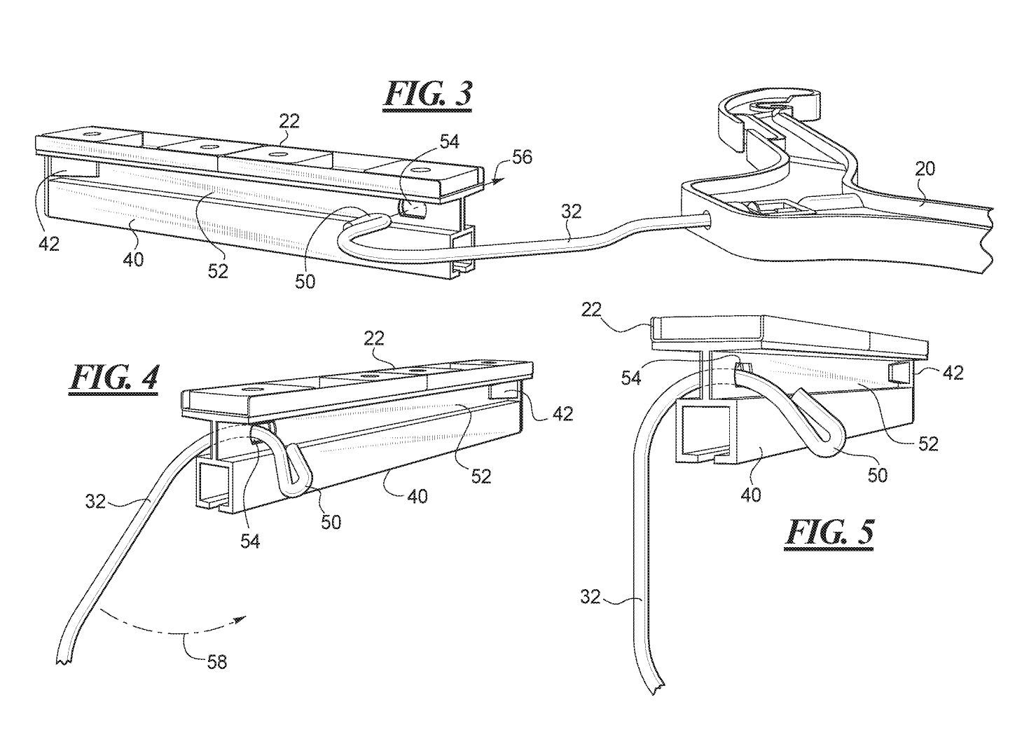

FIG. 3 shows the hanger 20 being mounted in the adapter 22. The hanger 20 has the hanger hook 32 formed of a metal wire with a loop 50 at the end of the hanger hook 32. The loop 50 is formed by bending the wire of the hanger hook 32 back on itself, as is common in clothing hangers. The adapter 22 has a neck 52 above the channel 40. In the neck 52 is formed an elongated opening 54 having a size and shape to accept the loop 50 at the end of the hanger hook 32 when the hanger hook 32 is turned to be generally parallel with the adapter 22. The loop 50 is passed through the opening 54 as indicated by arrow 56. The position of the adapter 22 and hanger 20 that permits engagement and disengagement may be described as aligned with one another.

In FIG. 4, the loop 50 at the end of the hanger hook 32 has been moved through the opening 54. The hook 32 is rotated from the parallel or aligned position in a direction of arrow 58. With reference to FIG. 5, the hook 32 is positioned generally perpendicular to the adapter 22 in a position with the hanger 20 hanging below and selectively engaged within the adapter 22. The opening 54 is shaped with a lesser vertical extent than its horizontal extent so that the loop 50 of the hanger hook 32 cannot pass through the opening while in the perpendicular position. The hanger 20 is thereby locked in position within the adapter 22 unless the hanger hook 32 and adapter 22 are once again moved to a generally parallel or aligned position relative to one another. Articles of clothing may be placed on the hanger 20 or removed from the hanger 20, the adapter 22 may be moved to the mounting position and moved from the mounting position, all with little risk that the hanger 20 will come out of the adapter 22.

A hanger 20 with a wire hanger hook 32 and loop 50 is shown. This type of hanger is commonly used for clothing displays. Other types of hangers may be used as well, including wire hangers, wooden hangers, plastic hangers, pants hangers, dress hangers, coat hangers, or other types of hangers. For hangers that do not have the loop formed at the end of the hanger hook, it may be unnecessary to move the hanger and adapter to an aligned and generally parallel position to engage or disengage the hanger hook from the adapter 22. Hangers having hanger hooks with a simple cut-off wire hook end may be used in the adapter. The hook shape of the hanger hook may retain the hanger in the adapter 22 without the loop 50. Other items may be hung from, placed in, or attached to the adapter 22 including at the elongated opening 54 or otherwise attached to, in, or on the adapter 22.

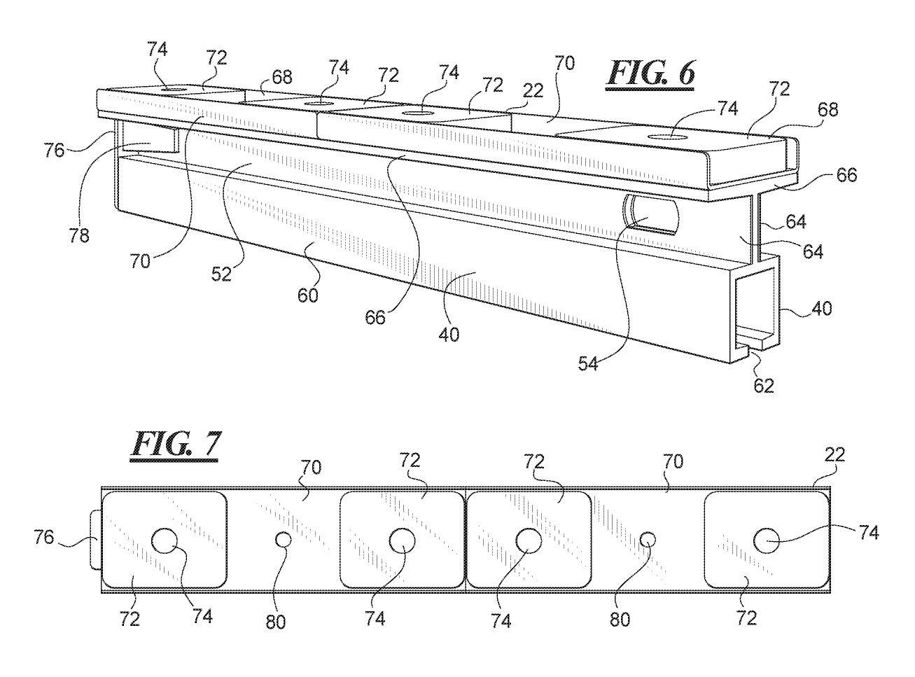

FIG. 6 shows the adapter 22. In the illustrated example, the adapter 22 includes a body 60 of plastic formed by extrusion. The body 60 includes the channel portion 40 that is generally in the shape of a square or rectangular tube with a slot 62 open to the bottom. Other shapes are possible such as round or triangular tube shapes. The channel 40 is connected to the neck 52. The neck 52 of the illustrated embodiment includes soft vinyl layers or strips 64 adhered to opposite sides thereof. The jaws of the gripper 24 may engage the layers or strips 64 to enhance the grip of the gripper 24 on the adapter 22 and reduce slipping during mounting and unmounting movements. The neck 52 connects to a top plate 66. On the top plate 66 are mounted magnets 68. In the example, the magnets 68 each include a metal U-shaped channel 70. In each U-shaped channel 70 are mounted two ceramic magnet elements 72. The magnet elements 72 are formed with a center hole 74 in the illustrated example. The magnet elements 72 may be secured in the U-shaped channels 70 by adhesive or glue and the U-shaped channels 70 may be secured to the top plate 66 by adhesive or glue.

The elongated opening 54 is formed through the neck 52 and the layers or strips 64. In the illustrated embodiment, the opening 54 has parallel linear top and bottom sides and semi-circular curved ends. Other shapes of the opening are also possible. The shape of the opening may be configured to prevent the hanger from coming out while moving the adapter 22 to the mounting location, but this is not required in every instance. A plurality of openings of this shape or another shape may be provided in the neck 52. For example, a plurality of openings of different shapes may be provided in the adapter, where the differently shaped openings are configured to accommodate different shapes and sizes of hanger hooks.

The illustrated embodiment includes an end cap 76. The end cap 76 closes the open end of the channel portion 40 and provides a finished appearance to the adapter 22. The end cap 76 may be further used as an end stop that helps to retain hanging hardware elements within the channel portion 40. A clamping finger 78 of the end cap 76 extends onto the neck 52. The end cap 76 is optional and may be provided or not, as desired.

FIG. 7 shows a top view of the adapter 22 including the metal U-shaped channels 70 that are mounted end-to-end in abutting relation in the illustrated embodiment. The channels 70 each include center holes 80. The holes 80 are optional and need not be provided. The channels 70 are of approximately the same width as the top plate 66 of the extrusion. The ceramic magnet elements 72 are positioned adjacent opposite ends of the channels 70. The magnets mounted in this manner provide strong magnetic holding strength. In certain examples, the magnets are sufficiently strong to hold several clothing items on display. For example, a shirt and jacket may be hung on the same hanger 20 to show a prospective purchaser how the shirt and jacket go together. More or fewer of the ceramic magnet elements (or other magnets) may be provided, depending on, for example, the desired display weight holding capacity of the adapter 22. For instance, a user may desire an adapter 22 that can support a heavier display. FIG. 7 also shows the end cap 76 on one end of the adapter 22. As noted, the end cap is optional and may be provided on both ends, one end, or on neither end.

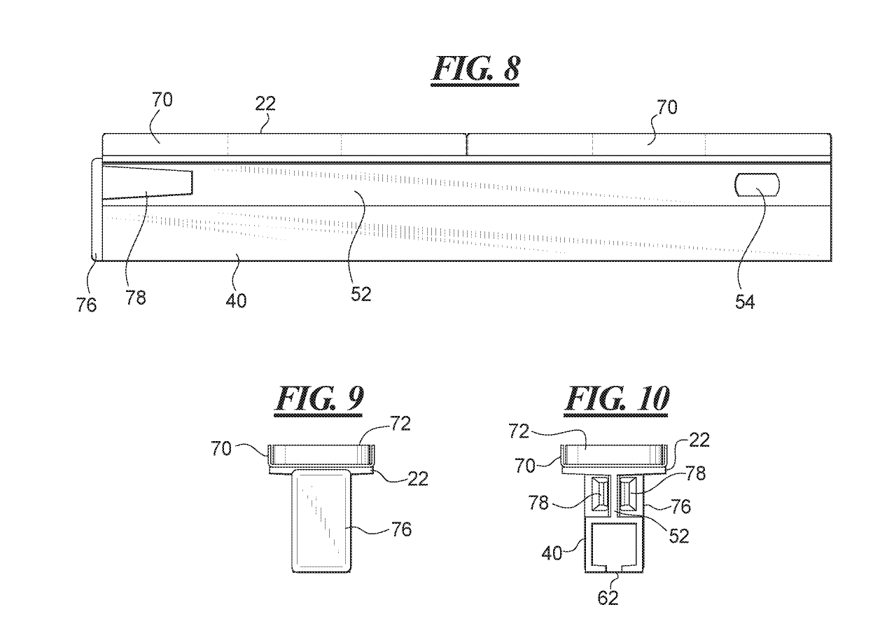

FIG. 8 shows the end cap 76. The clamping finger 78 extends onto the neck 52 a distance sufficient to cover the elongated opening 54 if the end cap 76 is attached to the end where an elongated opening 54 is provided on the adapter 22. The end cap 76 provides a finished appearance by covering the opening. It is also possible that the opening may be set inward from the end of the adapter 22 by a distance so that it remains open when an end cap 76 is used. In adapters 22 configured as shown, the end cap 76 cannot be provided if a hanger 20 is engaged through the opening 54. It is possible to use the end cap on an end at which the hanger 20 will not be engaged.

FIG. 9 shows the adapter 22 with the end cap 76 in place, providing a closed and finished look to the end of the adapter. FIG. 10 shows the view if the adapter 22 of FIG. 9 from the opposite end, showing two clamping fingers 78 of the end cap 76 engaged on opposite sides of the neck 52. The clamping fingers 78 engage the strips on the neck 52 to provide a secure engagement. The end cap 76 may prevent block end hooks or other display supporting elements from slipping out of the channel portion 40, such as during mounting and unmounting.

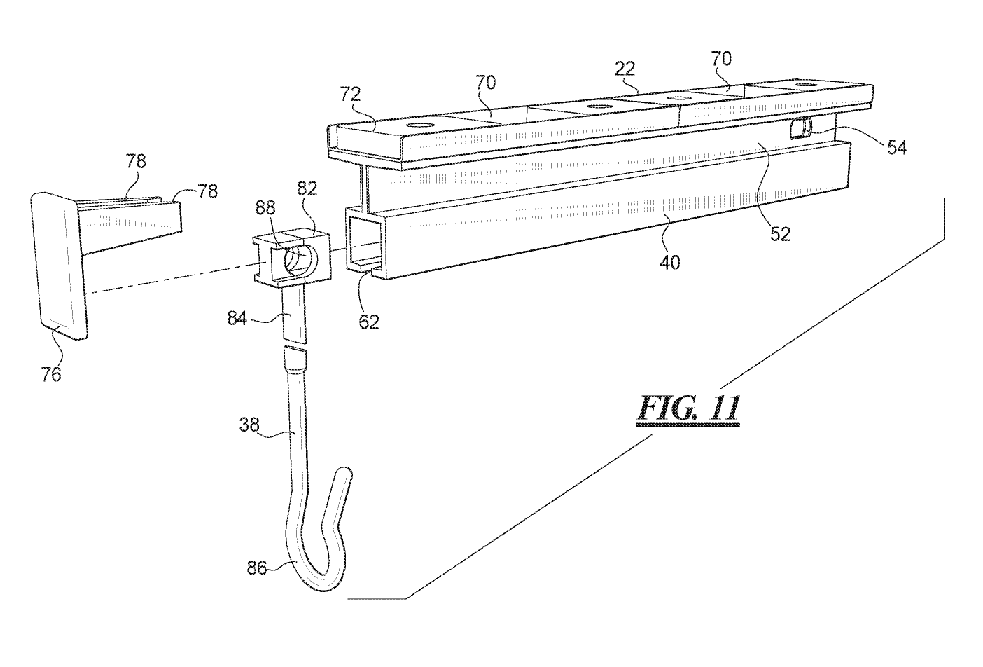

Turning to FIG. 11, the adapter 22 is being provided with a block end hook 38. The block end hook 38 includes a block 82 that is shaped to fit into the interior of the channel portion 40. A hook shaft 84 extends from the block 82 and passes through the slot 62 to extend out of the channel portion 40. The hook shaft 84 may be of any desired length. A hook 86 is on the end of the hook shaft 84 opposite the block 82. A hanger 20 or other display item may be connected to the hook 86. The hook 86 may be shaped to prevent inadvertent disconnection of the hanger 20 from the hook 86. Other shapes of the hook 86 are also possible including teardrop shaped, oval, or round, having open ends as shown or having closed, locking ends on the hooks. A hole 88 is provided in the block 82 by which the block 82 may be attached to a similar block end hook for further extending the display length below the adapter by using multiple block end hooks linked together as desired.

The end cap 76 has the two fingers 78 that fit onto opposite sides of the neck 52 to hold the end cap in place. When the display uses one or more block end hooks to hold a hanger, an end cap 76 may be provided at both ends. The end caps 76 help to prevent the block end hooks 38 from slipping out of the channel portion 40. The illustrated adapter 22 has a single opening 54 adjacent one end thereof. The opening is not needed if only the block end hooks or other display supporting devices are used to attach the display within the channel portion 40. However, the elongated opening 54 provides the flexibility for the user to use a hanger suspended directly in the opening if desired. Further, even if the elongated opening 54 is present, the two fingers 78 of the end cap 76 will still sufficiently grip onto the neck 52 to hold the end cap 76 in place.

Other display suspending devices may be inserted into the channel portion 40, as will be understood by those of skill in this art. Such other devices may include clips, loops, hooks, wires, dowels, cord, string, line winders, or any other devices.

In the illustrated embodiment, the adapter is approximately six inches in length. Other lengths are within the scope of this invention. The neck 52 adjacent the elongated opening is of sufficient length for the jaws of the gripper 24 to fit completely on the neck 52. In an example, the gripper 24 has jaws that are approximately four inches wide, leaving room on the adapter 22 for one or several hangers to be attached to the adapter 22 while providing room for the gripper 24 to still engage the neck 52.

Thus, there is shown and described an adapter for hanging a clothes hanger or other display device from a ceiling or other mounting location which includes a top plate on which are mounted magnets. A neck is connected to the top plate and a channel portion is connected to the neck. An opening is formed in the neck of a size and shape to accept a hook of a clothes hanger. The opening may be shaped to permit a loop end of the hanger hook to pass only when the adapter and hanger are aligned with one another.

Although other modifications and changes may be suggested by those skilled in the art, it is the intention of the inventors to embody within the patent warranted hereon all changes and modifications as reasonably and properly come within the scope of their contribution to the art.

1. An adapter for mounting a clothes hanger, comprising:
a body having a top plate, a neck extending from the top plate, and a channel member connected to the neck;
a plurality of magnets connected to the top plate; and
the neck defining an opening, the opening being shaped to accept a hanger hook when the hanger is aligned with the adapter and being shaped to prevent removal of the hanger hook from the opening when the hanger hook is not aligned with the adapter.

2. An adapter as claimed in claim 1, wherein the channel member includes a hollow channel portion with a slot opening into the hollow channel portion at a position opposite the neck, and further comprising:
a hanger support mounted in the slot and extending into the hollow channel portion, the hanger support including a portion extending from the channel member, the portion extending being configured to connect to a clothes hanger.

3. An adapter as claimed in claim 1, wherein the plurality of magnets each include a metal U-shaped channel and a plurality of magnet elements mounted in each metal U-shaped channel, the metal U-shaped channels of the plurality of magnets being mounted on the top plate abutting one another.

4. An adapter as claimed in claim 1, further comprising:
a gripper having first and second opposed jaws of a predetermined width;
a pole connected to the gripper;
a rope connected to the first jaw; and
the body being of a length greater than the predetermined width of the jaws.

5. An adapter as claimed in claim 1, wherein the body is formed of an extrusion having approximately uniform dimensions along its length.

6. A method for mounting an article of clothing at a display location, comprising in any order:
mounting an article of clothing on a hanger;
attaching the hanger to an adapter by aligning a hanger hook to a position approximately parallel to a horizontal axis of the adapter;
moving the hanger from the parallel position to a perpendicular position to the horizontal axis while attached to the adapter, the hanger being prevented from being removed from the adapter while in the perpendicular position;
gripping the adapter in a gripper;
moving the gripper with the adapter held in it to a display position;
magnetically engaging the adapter to the display location;
releasing the gripper from the adapter so that the adapter and article of clothing remain at the display location, the adapter being disposed with the horizontal axis in a horizontal position at the display location, the hanger extending perpendicular to the horizontal axis at the display location.

7. A method as claimed in claim 6, wherein the attaching includes passing a loop at an end of a hook of the hanger through an elongated opening in the adapter; and
wherein the moving includes rotating the hanger to a position approximately perpendicular to the horizontal axis of the adapter while the loop at the end of the hook extends through the elongated opening.

8. An adapter as claimed in claim 1, wherein the opening includes first and second opposite edges of the opening, the first and second opposite edges extending straight for a predetermined distance, the first and second opposite edges extending parallel to the top plate.

9. An adapter as claimed in claim 1, wherein the opening having a first diameter in a direction perpendicular to the top plate and a second diameter in a direction parallel to the top plate, the second diameter being greater than the first diameter.

10. An adapter as claimed in claim 1, wherein the adapter is structured for use with a clothes hanger having a hook with a hook end, the hook end having a first diameter parallel to the hook that is greater than a second diameter perpendicular to the hook;
the opening having a first diameter perpendicular to the top plate that is greater than the second diameter of the hook end but less than the first diameter of the hook end, the opening having a second diameter that is greater than the first diameter of the hook end.

11. An adapter for mounting a clothes hanger, the clothes hanger having a hanger hook, the adapter comprising:
a body having a top plate, the body being configured for mounting to a ceiling with a body axis in a horizontal position;
at least one magnet mounted to the top plate, the magnet being disposed for magnetic mounting to a ceiling with the body in the horizontal position; and
the body defining an elongated opening, the elongated opening having a long axis extending parallel to the body axis and a short axis perpendicular to the body axis, the elongated opening being shaped to accept the hanger hook when the hanger is aligned with the body axis, the elongated opening being shaped to prevent removal of the hanger hook from the elongated opening when the clothes hanger is hanging from the adapter with the body in the horizontal position.

12. An adapter as claimed in claim 11, further comprising:
a gripper engagement portion on the body, the gripper engagement portion being shaped for engagement by a gripper, the gripper engagement portion being disposed for mounting the adapter to and unmounting the adapter from a ceiling while a clothes hanger is engaged in the elongated opening, the adapter being configured for the mounting and unmounting without the hanger becoming aligned with the body axis, the hanger thereby being retained in the adapter during mounting and unmounting.
